(19) United States
(12) Patent Application Publication
(10) Pub. No.: US 2008/0241791 A1
(43) Pub. Date: Oct. 2, 2008

(54) IMPLANT THREAD DESIGN

(75) Inventors: Ronald A. Bulard, Ardmore, OK (US); Ronald Floyd, Ardmore, OK (US)

Correspondence Address: NORRIS, MCLAUGHLIN & MARCUS, PA, 875 THIRD AVENUE, 18TH FLOOR, NEW YORK, NY, 10022, US

(73) Assignee: IMTEC Corporation, Ardmore, OK (US)

(21) Appl. No.: 12/059,010

(22) Filed: Mar. 31, 2008

Related U.S. Application Data
(60) Provisional application No. 60/921,428, filed on Mar. 31, 2007.
(60) Provisional application No. 60/923,266, filed on Apr. 14, 2007.

(51) Int. Cl. A61C 8/00

(52) U.S. Cl. 433/174

(57) ABSTRACT

A one-piece dental implant characterized by a threaded shaft having self-tapping cutting threads of variable thread pitch and optionally one or more flutes running longitudinally along at least a portion of the length of the dental implant and across a plurality of turns of the self-tapping cutting threads. The dental implant is useful to support both temporary and permanent prostheses as well as orthodontic appliances.

### CROSS-REFERENCE TO RELATED APPLICATION

This application claims priority pursuant to 35 U.S.C. § 119(e) of U.S. Provisional Application No. 60/921,428, filed on Mar. 31, 2007; and of U.S. Provisional Application No. 60/923,266, filed on Apr. 14, 2007.

### BACKGROUND OF THE INVENTION

1. Field of the Invention

The present invention relates to dental implants.

2. Description of Related Art

Dental implants are in widespread use for placing both temporary and permanent prostheses. Examples of such dental implants can be found in U.S. Pat. Nos. 5,749,732; 6,716,030; and 7,112,063; and U.S. Pre-Grant Publication Nos. 2006/0269903 and 2006/0275,735.

Nevertheless, there is a continuing need to develop dental implants with features that improve or facilitate the placement of the dental implants into jawbone and/or improve the integration of the dental implant into the jawbone once placed.

U.S. Pat. No. 6,402,515 describes a dental implant comprising threads of continuously expanding widths from the apical end towards the coronal end. A stated advantage of such a configuration is that stability in low-density bone is enhanced.

U.S. Pat. No. 5,871,486 describes a bone screw having threads of continuously varying pitch. According to this patent, the pitch of the screw decreases between the leading and trailing ends and this causes two bone fragments of a bone fracture to be drawn together when the screw is inserted. There is no teaching in this patent of any applicability of such a screw to dental implants.

### SUMMARY OF THE INVENTION

The present invention relates, in a first embodiment, to a one-piece dental implant for placement into bone, wherein the one-piece dental implant extends between a first end and a second end, and the one-piece dental implant comprises the following distinct regions integrated into one piece:
a) a threaded shaft tapering to a point at the first end, wherein the threaded shaft comprises a first group of self-tapping cutting threads having a first thread pitch and a second group of cutting threads having a second thread pitch, wherein the first thread pitch is different from the second thread pitch;
b) a head at said second end;
c) optionally a circular or non-circular abutment positioned between the threaded shaft and the head;
d) optionally an outwardly tapering smooth collar positioned between the threaded shaft and the head; and
e) optionally one or more flutes running longitudinally along at least a portion of the length of the implant and across a plurality of turns of the self-tapping cutting threads.

The term “thread pitch” as used herein means the distance from one point on a thread to the corresponding point on an adjacent thread. For example, the first thread pitch is greater than the second thread pitch when the distance between any two adjacent threads in the first group of self-tapping cutting threads is greater than the distance between any two adjacent threads in the second group of self-tapping cutting threads.

The term “flute(s)” as used therein means a groove.

The present invention relates in a second embodiment to a method of inserting a dental implant into the jawbone of a patient, wherein the method comprises:
a) providing the inventive dental implant;
b) inserting the dental implant through gum tissue overlying the jawbone of the patient into the jawbone of the patient.

The present invention relates in a third embodiment to a method of securing a removable prosthesis to the jawbone of a patient, wherein the method comprises:
a) providing the inventive dental implant;
b) inserting the dental implant into the jawbone of a patient;
c) providing a removable prosthesis; and
d) removably securing the removable prosthesis to the dental implant.

The present invention relates in a fourth embodiment to a method of securing a fixed prosthesis to the jawbone of a patient, wherein the method comprises:
a) providing the inventive dental implant;
b) inserting the dental implant into the jawbone of a patient; and
c) securing the fixed prosthesis to the jawbone of the patient by fixing the prosthesis to the dental implant.

The present invention relates in a fifth embodiment to a combination comprising:
a) the inventive dental implant; and
b) a retrofit head adapted to fit over the head of the dental implant and to be secured to the dental implant.

The present invention relates in a sixth embodiment to a method of inserting a combination dental implant and retrofit head into the jawbone of a patient, wherein the method comprises:
a) providing the combination;
b) inserting the combination or the dental implant only through gum tissue overlying the jawbone of the patient into the jawbone of the patient; and
c) fitting the retrofit head onto the dental implant in the event that the inserting was of the dental implant only.

### BRIEF DESCRIPTION OF THE DRAWINGS

The invention will now be described in greater detail with reference to the drawings, wherein:

FIG. 1 is a schematic depicting a section of the threaded shaft of a dental implant according to the present invention;

FIG. 2 is a schematic depicting a section of the threaded shaft of another dental implant according to the present invention; and

FIG. 3 is an end view of another dental implant according to the present invention viewed from the point towards the head.

### DETAILED DESCRIPTION OF THE INVENTION

The improvements described herein are applicable to any dental implant. Thus, for example, the dental implant may, merely for illustration, be any type of implant known in the art that is modified to have the thread pattern and/or flute(s) described herein. Preference is, however, given to small diameter implants, for example, as are disclosed in U.S. Pat. Nos. 5,749,732; 6,716,030; and 7,112,063; and U.S. Pre-Grant Publication Nos. 2006/0269903; and 2006/0275,735; the entire contents of which patents and published applications are hereby incorporated fully by reference as to the implant design and type and the implant insertion protocols. The incorporated patents describe implant dimensions, materials, placement protocols, suitable head shapes and thread designs, all of which, by virtue of their incorporation, are considered repeated herein.

The term “small diameter implant” as used herein means an implant less than 4.0 mm in diameter, preferably less than 3.5 mm in diameter, especially less than 2.0 mm in diameter. Small diameter implants permit insertion of the implant directly through the soft tissue into the underlying bone without any flap surgery incisions or sutures making for a much more patient-friendly procedure than is typical of larger size implant systems. In a particularly preferred insertion procedure, a pilot hole about 4 to 8 mm in length is drilled directly through the patient's gum and into the jawbone therebelow. A dental implant having a diameter greater than that of the pilot hole is then installed through said pilot hole into the patient's jawbone. In an especially preferred embodiment, a dental stent is used as a guide, for example, the dental stent described in U.S. Provisional Application No. 60/906,405, filed on Mar. 12, 2007; and U.S. Non-Provisional application Ser. No. 12/047,140, filed on Mar. 12, 2008, the entire contents of both of which applications are hereby incorporated herein by reference.

Suitable heads are any known in the art. For example, the head may be any of the types described in the above-identified patents and published applications or any other type now used or in the future found to be useful in the art. Suitable head shapes include, but are not limited to, square, ball-shaped, oval, triangular, mushroom. Alternatively or in addition to, the head may be fitted with an i-hook, a square hole, a round hole, or a groove, or any other suitable combination of convex and concave surfaces optionally having flat portions as desired. The head shape can be irregular, if desired, but may also be regular. The shape of the head really is a matter of design choice, well within the skill of the ordinary practitioners in this art. Alternatively, the head can have a shape that is capable of accepting and removably retaining an O-ball, for example, an O-ball descending from the prosthesis itself. For example, the head of the inventive dental implant may be latched or slotted, allowing the head to latch and grip an O-ball. In the case of an oval-shaped head, a triangle-shaped head or a mushroom-shaped head, the head can retain a conventional O-ring, but use can also be made of a keeper cap adapted to be secured to the dental implant via the O-ring or a plastic insert specifically designed to accept and releasably grip the head.

In a preferred embodiment, the dental implant extends between a first end and a second end, and comprises the following distinct regions formed into one piece:
a) a threaded shaft tapering to a point at the first end;
b) a head at the second end, the head permitting a dental prosthesis to be mounted thereon; and
c) optionally a circular or non-circular abutment positioned between the threaded shaft and the head.

In one preferred embodiment, the dental implant has a head having a shape which is capable of accepting and releasably retaining a keeper cap or an O-ring.

In another preferred embodiment, the dental implant has a head having a shape which is capable of accepting and retaining a dental wire.

In another preferred embodiment, the dental implant has a head having a shape which is capable of accepting and releasably retaining an O-ball.

In an especially preferred embodiment, the dental implant has a ball-shaped head.

In another especially preferred embodiment, the dental implant has a square and/or tapered head.

In another especially preferred embodiment, the dental implant has a head that has an irregular surface.

In yet another especially preferred embodiment, the dental implant has a head that has a mushroom shaped and/or is fitted with a groove.

In one preferred embodiment, the dental implant has a circular or non-circular abutment positioned between said threaded shaft and said head.

In one especially preferred embodiment, the abutment is circular.

In another especially preferred embodiment, the abutment is non-circular. This non-circular abutment can be any shape, but is preferably of square, triangular, hexagonal or any other shape that permits threaded advance of the shaft by fingers or tools, for example, a wrench or a ratchet.

In another preferred embodiment, the dental implant has an outwardly tapering smooth collar positioned between said threaded shaft and said head.

As noted above, the inventive dental implant comprises a threaded shaft, which, in turn, comprises a first group of self-tapping cutting threads having a first thread pitch and a second group of cutting threads having a second thread pitch, wherein the first thread pitch is different from the second thread pitch. As also noted above, the term “thread pitch” as used herein means the distance from one point on a thread to the corresponding point on an adjacent thread. For example, the first thread pitch is greater than the second thread pitch when the distance between any two adjacent threads in the first group of self-tapping cutting threads is greater than the distance between any two adjacent threads in the second group of cutting threads.

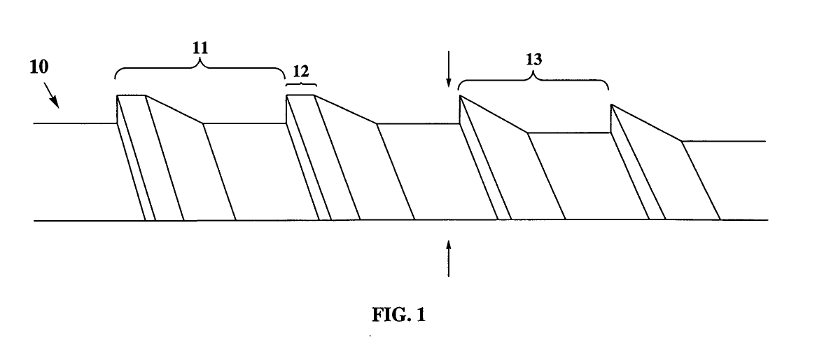

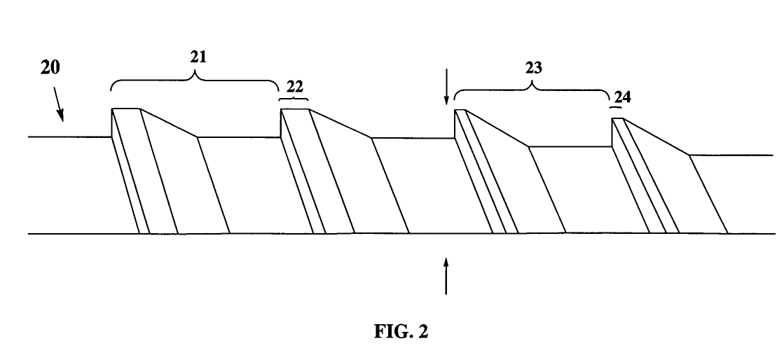

Referring to FIG. 1, there is depicted dental implant 10, which comprises a first group of self-tapping cutting threads to the right of the portion marked by the arrows and a second group of cutting threads to the left of the portion marked by the arrows. In this particular embodiment, the arrows also just happen to demarcate a transition point between a non-tapering portion of the threaded shaft to the left of the portion marked by the arrows and a tapering portion of the threaded shaft to the right of the portion marked by the arrows. At least two adjacent threads in the first group of self-tapping cutting threads are characterized by a first thread pitch 13. Similarly, at least two adjacent threads in the second group of threads are characterized by a second thread pitch 11. According to the present invention, first thread pitch 13 is different from second thread pitch 11. Similarly, referring to FIG. 2, dental implant 20 is characterized by first thread pitch 23 being different from second thread pitch 21.

In an especially preferred embodiment, the dental implant has any of the preferred or especially preferred features above and/or comprises a thread pattern wherein said first thread pitch is greater than said second thread pitch.

In another especially preferred embodiment, the dental implant has any of the preferred or especially preferred features above and/or comprises a thread pattern wherein said second thread pitch is greater than said first thread pitch.

It is possible to have more than two groups of either self-tapping cutting threads and/or non-self-tapping non-cutting threads, with each having differing thread pitches, for example, three or four or five or six such groups.

It is also possible to design an implant where thread pitch increases constantly along the thread length beginning from the point proceeding in the direction of the head.

Alternatively, it is possible that thread pitch decreases constantly along the thread length from the point towards the head.

In the most preferred embodiment, the dental implant has a dual thread profile, i.e., two groups of cutting threads having differing thread pitches. Where the dental implant has a dual thread profile, the most preferred arrangement is that the threads on a non-tapered portion of the threaded shaft have a first thread pitch and the threads on the tapered portion of the threaded shaft have a second thread pitch. However, it is also possible that some of the threads on the non-tapered portion have a first thread pitch and other threads on the non-tapered portion have a second thread pitch. Likewise, it is also possible that some of the threads on the tapered portion have a first thread pitch and other threads on the tapered portion have a second thread pitch.

Having threads of differing thread pitch may be beneficial clinically in compressing bone within the placement site and creating additional stability for placing implant into bone and immediately loading the bone. There may also be enhanced benefits in the orthodontic implant industry, where different forces (other than the occlusal forces inherent in denture stabilization) affect the dynamics of implant retention in bone.

Referring again to FIG. 1, purely for illustration purposes only, and without intending to be limiting, the depicted threads in said second group of cutting threads are characterized by a first crest width 12. Referring to FIG. 2, the first group of self-tapping cutting threads is characterized by a first crest width 24 and the second group of threads is characterized by a second crest width 22. According to the present invention, the first crest width can be the same as or different from the second crest width.

In another especially preferred embodiment, the dental implant has any of the preferred or especially preferred features above and/or comprises a thread pattern wherein the first crest width is greater than said second crest width.

In another especially preferred embodiment, the dental implant has any of the preferred or especially preferred features above and/or comprises a thread pattern wherein the second crest width is greater than said first crest width. In another especially preferred embodiment, the dental implant has any of the preferred or especially preferred features above and/or comprises a thread pattern wherein the first thread pitch correlates to a first crest width and the second thread pitch correlates to a second crest width and said first crest width is greater than said second crest width.

In another especially preferred embodiment, the dental implant has any of the preferred or especially preferred features above and/or comprises a thread pattern wherein the first thread pitch correlates to a first crest width and the second thread pitch correlates to a second crest width and said second crest width is greater than said first crest width.

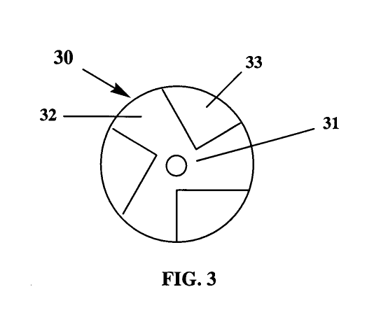

In another especially preferred embodiment, the dental implant has any of the preferred or especially preferred features above and/or comprises a thread pattern which comprises one or more flutes running, preferably from the point, longitudinally along at least a portion of the length of the implant and across a plurality of turns of the self-tapping cutting threads. Referring to FIG. 3, there is shown an end view of dental implant 30 viewed from the point 31 towards head (not shown). The generally cylindrical shape of this first end of the implant is interrupted by a plurality of flutes 33 in this case carved into the metal, leaving a plurality of metal projections 32 spaced about the circumference. The presence of flutes allows the implant to pierce, drill, cut the jawbone, compact the jawbone and self-tap all in one motion. The presence of flutes also facilitates self-tapping of the dental implant through the pilot hole and thereby lessens the need to first drill a full-depth osteotomy. The number of flutes and/or their spacing can be designed as desired.

In an especially preferred embodiment, the dental implant has any of the preferred or especially preferred features above and/or comprises a thread pattern which comprises three such flutes spaced approximately 120° apart around a circumference of the point.

In another especially preferred embodiment, the dental implant with such flutes may have a threaded shaft with a width of approximately 2.5 mm to 3.5 mm.

The inventive dental implant can be placed according to procedures well known in the art, including after drilling a full-bore osteotomy site. The preferred insertion protocol is set forth in U.S. Pat. Nos. 5,749,732; 6,716,030; and 7,112,063; and U.S. Pre-Grant Publication Nos. 2006/0269903; and 2006/0275,735; the entire contents of which patents and published applications have already been fully incorporated herein by reference. In the preferred method, the dental implant is inserted into the patient's jawbone by inserting the dental implant through gum tissue overlying the jawbone of the patient into the jawbone of the patient, i.e., without surgically opening a flap in the gum tissue. In a particularly preferred insertion procedure, a pilot hole about 4 to 8 mm in length is drilled directly through the patient's gum and into the jawbone therebelow. A dental implant having a diameter greater than that of the pilot hole is then installed through the pilot hole into the patient's jawbone. In an especially preferred embodiment, a dental stent is used as a guide, for example, the dental stent described in aforementioned U.S. Provisional Application No. 60/906,405; and U.S. Non-Provisional application Ser. No. 12/047,140, the entire contents of both of which applications have already been fully incorporated herein by reference. In a preferred insertion protocol, the dental implant has a circular or non-circular abutment between the threaded shaft and the head, and the circular or non-circular abutment is gripped with a tool or one's fingers and advanced through the gum tissue into the jawbone of the patient. In another preferred insertion protocol, the dental implant has or does not have the circular or non-circular abutment, and the dental implant is advanced by gripping the head of the dental implant with a tool or with one's fingers and advancing the dental implant through the gum tissue into the jawbone of the patient by turning the head.

Once the dental implant has been placed into the patient's jawbone, a removable prosthesis can be removably secured to the seated dental implant. In a preferred embodiment, the removable prosthesis is formed around a keeper cap containing an O-ring-shaped insert or a plastic insert, and the removable prosthesis is removably secured to the dental implant by attaching the keeper cap via said O-ring-shaped insert or said plastic insert to the dental implant.

In a similar manner, a fixed prosthesis can also be secured to the seated dental implant.

In a similar manner, an orthodontic appliance can also be secured to the seated dental implant. In a preferred embodiment, the orthodontic appliance is a dental wire, orthodontic elastomers or other orthodontic appliances to the dental implant.

The present invention also relates to a combination of the inventive dental implant and a retrofit head adapted to fit over the head of the dental implant and to be secured to the dental implant. In a preferred embodiment, the retrofit head itself has a head having a shape which is capable of accepting and releasably retaining a keeper cap or an O-ring, or which is capable of accepting and retaining a dental wire, or which is capable of accepting and releasably retaining an O-ball.

The combination dental implant and retrofit head can be inserted into the jawbone of the patient in the same manner described hereinabove, i.e., by inserting the combination or the dental implant only through gum tissue overlying the jawbone of the patient into the jawbone of the patient; and fitting the retrofit head onto the dental implant in the event that the inserting was of the dental implant only.

Without wishing to be limited, the dental implant according to the present invention is most preferably composed of titanium or an alloy thereof. The dental implant is formed of any strong metal or alloy thereof, and especially from titanium or an alloy thereof with another metal, for example, aluminum and/or vanadium. The best mode is to use a titanium alloy rod having the formula Ti6Al4V, which satisfies the American Society for Testing Materials F-136 (ASTM F-136).

In this most preferred, non-limiting embodiment, dimensions can be varied over a wide range, with the limiting factor for this most preferred embodiment being the suitability of the implant in the nonsurgical method described hereinabove as incorporated by reference from the prior patents and publications mentioned. Without intending to limit the scope of the invention in any manner, as other dimensions may well prove to be suitable in the nonsurgical method depending upon the materials employed and the intended use, and, especially for orthodontic applications, the inventive dental implant can range in overall length from about 9 mm to about 20 mm or more, preferably from about 11 mm to about 13 mm. The length of the threaded shaft likewise can range from about 4 mm to about 15 mm, preferably from about 6 mm to about 8 mm; and the width of the thickest portion of the threaded shaft can range from 0.5 to about 3.5 mm, and is, preferably, about 1.8 mm. The threaded shaft may be fitted with an antirotational flat, as described in the prior patents and publications mentioned, but, as described in these documents, this is advantageous, but not critical. When the implant comprises an antirotational flat, then the length of the flat in the longitudinal direction of the threaded shaft ranges in length from about 0.5 mm to about 4 mm, and is preferably about 1 mm, and the width of the threaded shaft at the flat is about 0.8 mm to about 1.8 mm, preferably about 1.2 mm. The edge of the antirotational flat nearest the point of the tapered shaft begins about 2 mm to about 4 mm therefrom, preferably about 3 mm therefrom. The circular or non-circular abutment, if present, ranges in length from about 0.5 mm to about 2 mm, preferably about 1 in length, and has a width of about 1.4 mm to about 2.5 mm, preferably about 1.65 mm. The head, which, as indicated above, can vary in shape, ranges in length from about 0.5 mm to about 1.5 mm, and is preferably about 0.8 in length, and has a width of about 0.5 mm to about 2.8 mm, preferably about 1.4 mm. The head is normally attached indirectly to the circular or non-circular abutment, if present, by a neck of some sort, which ranges in length from about 0.5 mm to about 1.5 mm, preferably about 0.8 mm. Again, these dimensions are for illustration purposes only, as were those mentioned in the prior patents and applications mentioned, and the only limiting factor, again, is the suitability of the implant in the nonsurgical method described.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

1. A one-piece dental implant for placement into bone, said one-piece dental implant extending between a first end and a second end, and said one-piece dental implant comprising the following distinct regions integrated into one piece:
a) a threaded shaft tapering to a point at said first end, said threaded shaft comprising a first group of self-tapping cutting threads having a first thread pitch and a second group of cutting threads having a second thread pitch, wherein said first thread pitch is different from said second thread pitch;
b) a head at said second end;
c) optionally a circular or non-circular abutment positioned between said threaded shaft and said head;
d) optionally an outwardly tapering smooth collar positioned between said threaded shaft and said head; and
e) optionally one or more flutes running longitudinally along at least a portion of the length of the implant and across a plurality of turns of the self-tapping cutting threads.

2. The dental implant according to claim 1, which has a head having a shape which is capable of accepting and releasably retaining a keeper cap or an O-ring.

3. The dental implant according to claim 1, which has a head having a shape which is capable of accepting and retaining a dental wire.

4. The dental implant according to claim 1, which has a head having a shape which is capable of accepting and releasably retaining an O-ball.

5. The dental implant according to claim 1, which has a circular or non-circular abutment positioned between said threaded shaft and said head.

6. The dental implant according to claim 1, which has an outwardly tapering smooth collar positioned between said threaded shaft and said head.

7. The dental implant according to claim 1, which has a ball-shaped head.

8. The dental implant according to claim 1, which has a square and/or a tapered head.

9. The dental implant according to claim 1, which has a head that has an irregular surface.

10. The dental implant according to claim 1, wherein the head has a mushroom shaped and/or is fitted with a groove.

11. The dental implant according to claim 1, wherein said first thread pitch is greater than said second thread pitch.

12. The dental implant according to claim 1, wherein said second thread pitch is greater than said first thread pitch.

13. The dental implant according to claim 1, wherein the first thread pitch correlates to a first crest width and the second thread pitch correlates to a second crest width and said first crest width is different than said second crest width.

14. The dental implant according to claim 1, wherein the first thread pitch correlates to a first crest width and the second thread pitch correlates to a second crest width and said second crest width is different than said first crest width.

15. The dental implant according to claim 1, which comprises one or more flutes running longitudinally along at least a portion of the length of the implant and across a plurality of turns of the self-tapping cutting threads.

16. The dental implant according to claim 15, which comprises three such flutes spaced approximately 120° apart around a circumference of said point.

17. A method of inserting a dental implant into the jawbone of a patient, said method comprising:
a) providing a dental implant according to claim 1;
b) inserting said dental implant through gum tissue overlying the jawbone of the patient into the jawbone of the patient.

18. The method according to claim 17, wherein said inserting involves gripping the head of said dental implant with a tool or with one's fingers and advancing the dental implant through the gum tissue into the jawbone of the patient.

19. A method of securing a removable prosthesis to the jawbone of a patient, said method comprising:
a) providing a dental implant according to claim 1;
b) inserting said dental implant into the jawbone of a patient;
c) providing a removable prosthesis; and
d) removably securing the removable prosthesis to said dental implant.

20. The method according to claim 19, wherein the removable prosthesis is formed around a keeper cap containing an O-ring-shaped insert or a plastic insert, and said removable prosthesis is removably secured by attaching the keeper cap via said O-ring-shaped insert or said plastic insert to said dental implant.

21. A method of securing a fixed prosthesis to the jawbone of a patient, said method comprising:
a) providing a dental implant according to claim 1;
b) inserting said dental implant into the jawbone of a patient; and
c) securing the fixed prosthesis to the jawbone of the patient by fixing the prosthesis to the dental implant.

22. A method of securing an orthodontic appliance to the jawbone of a patient, said method comprising:
a) providing a dental implant according to claim 1;
b) inserting said dental implant into the jawbone of a patient; and
c) securing a dental wire, orthodontic elastomers or other orthodontic appliances to the dental implant.

23. A combination comprising:
a) a dental implant according to claim 1; and
b) a retrofit head adapted to fit over the head of said dental implant and to be secured to said dental implant.

24. A method of inserting a combination dental implant and retrofit head into the jawbone of a patient, said method comprising:
a) providing a combination according to claim 23;
b) inserting the combination or the dental implant only through gum tissue overlying the jawbone of the patient into the jawbone of the patient; and
c) fitting the retrofit head onto the dental implant in the event that said inserting was of the dental implant only.
